(19) United States
(12) Patent Application Publication
(10) Pub. No.: US 2025/0232490 A1
(43) Pub. Date: Jul. 17, 2025

(54) POPULATION-BASED DATA-DRIVEN GATING BASED ON CLUSTERING SHORT-FRAME DATA FEATURES

(71) Applicants: CANON MEDICAL SYSTEMS CORPORATION, Tochigi (JP); THE REGENTS OF THE UNIVERSITY OF CALIFORNIA, Oakland, CA (US)

(72) Inventors: Jinyi QI, Oakland, CA (US); Wenyuan QI, Vernon Hills, IL (US); Li YANG, Vernon Hills, IL (US); Evren ASMA, Vernon Hills, IL (US); Jeffrey KOLTHAMMER, Vernon Hills, IL (US)

(73) Assignees: CANON MEDICAL SYSTEMS CORPORATION, Tochigi (JP); THE REGENTS OF THE UNIVERSITY OF CALIFORNIA, Oakland, CA (US)

(21) Appl. No.: 19/017,229

(22) Filed: Jan. 10, 2025

Related U.S. Application Data
(60) Provisional application No. 63/620,519, filed on Jan. 12, 2024.

(51) Int. Cl. G06T 11/00; G06T 7/10; G06V 10/77; G06V 10/82

(52) U.S. Cl. CPC G06T 11/005; G06T 7/10; G06V 10/7715; G06V 10/82; G06T 2207/10104

(57) ABSTRACT

A method for gating positron emission tomography (PET) data, including receiving tomography data acquired by imaging an object using a PET apparatus, segmenting the received tomography data into a plurality of bins of tomography data, generating a latent feature vector for each bin of the plurality of bins of tomography data using a feature extraction neural network, the feature extraction neural network being pre-trained to extract latent feature vectors on a set of training data, clustering the generated latent feature vectors; and reconstructing an image using the received tomography data based on the clustering of the generated latent feature vectors.

### CROSS-REFERENCE TO RELATED APPLICATIONS

The present application claims priority to U.S. Patent Application No. 63/620,519, which was filed Jan. 12, 2024, and which is incorporated herein by reference in its entirety for all purposes.

### FIELD

The present disclosure is related to gating of positron emission tomography (PET) data.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Patient motion is a main source of blurring and artifacts in positron emission tomography (PET) imaging. Respiratory motion and cardiac motion during PET data acquisition can degrade quantitation performance by blurring images, leading to over-estimation of lesion volumes and under-estimation of lesion activity. Gating methods have been used to improve the quality of PET images. Typically, these methods need to use an external device to detect a biosignal, for example, a respiration waveform, electrocardiogramhy (ECG), etc. In some contexts, motion correction can be addressed by gating acquired data in which motion may have occurred. Gating involves dividing data into separates chunks (gates) within which motion is negligible.

### SUMMARY

In one embodiment, the present disclosure relates to a method for gating positron emission tomography (PET) data, the method comprising receiving tomography data acquired by imaging an object using a PET apparatus; segmenting the received tomography data into a plurality of bins of tomography data; generating a latent feature vector for each bin of the plurality of bins of tomography data using a feature extraction neural network, the feature extraction neural network being pre-trained to extract latent feature vectors on a set of training data; clustering the generated latent feature vectors; and reconstructing an image using the received tomography data based on the clustering of the generated latent feature vectors.

In one embodiment, the present disclosure relates to a positron emission tomography (PET) apparatus, comprising: processing circuitry configured to acquire tomography data by imaging an object using PET, segment the acquired tomography data into a plurality of bins of tomography data, generate a latent feature vector for each bin of the plurality of bins of tomography data using a feature extraction neural network, the feature extraction neural network being pre-trained to extract latent feature vectors on a set of training data, cluster the generated latent feature vectors, and reconstruct an image using the acquired tomography data based on the clustering of the generated latent feature vectors.

In one embodiment, the present disclosure relates to a non-transitory computer-readable storage medium for storing computer readable instructions that, when executed by a computer, cause the computer to perform a method, the method comprising: receiving tomography data acquired by imaging an object using a PET apparatus; segmenting the received tomography data into a plurality of bins of tomography data; generating a latent feature vector for each of the bins using a feature extraction neural network, the feature extraction neural network being trained on a set of training data; clustering the generated latent feature vectors; and reconstructing an image using the received tomography data based on the clustering of the latent feature vectors.

Note that this summary section does not specify every embodiment and/or incrementally novel aspect of the present disclosure or claimed invention. Instead, the summary only provides a preliminary discussion of different embodiments and corresponding points of novelty. For additional details and/or possible perspectives of the disclosure and embodiments, the reader is directed to the Detailed Description section and corresponding figures of the present disclosure as further discussed below.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a schematic of an encoder/decoder network, according to one embodiment of the present disclosure;

FIG. 1B is a schematic of an encoder/decoder network, according to one embodiment of the present disclosure;

FIG. 2 is an architecture of an encoder/decoder network, according to one embodiment of the present disclosure;

FIG. 3A is a schematic of encoding latent feature vectors, according to one embodiment of the present disclosure;

FIG. 3B is a schematic of clusters of latent feature vectors, according to one embodiment of the present disclosure;

FIG. 3C is a schematic of clusters of latent feature vectors, according to one embodiment of the present disclosure;

FIG. 3D is a schematic of clusters of latent feature vectors, according to one embodiment of the present disclosure;

FIG. 3E is a schematic of clusters of latent feature vectors, according to one embodiment of the present disclosure;

FIG. 4 is a method of pre-training an encoder, according to one embodiment of the present disclosure;

FIG. 5 is a method for clinical implementation of a pre-trained encoder, according to one embodiment of the present disclosure;

FIG. 6A is an extracted respiratory waveform, according to one embodiment of the present disclosure;

FIG. 6B is an extracted respiratory waveform, according to one embodiment of the present disclosure;

FIG. 7A is a reconstructed tomography image, according to one embodiment of the present disclosure;

FIG. 7B is a reconstructed tomography image, according to one embodiment of the present disclosure;

FIG. 7C is a reconstructed tomography image, according to one embodiment of the present disclosure;

FIG. 8A is an illustration of a perspective view of a PET scanner apparatus, according to embodiments of the present disclosure; and

FIG. 8B is a schematic of a PET scanner apparatus and associated hardware, according to embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting.

For example, the order of discussion of the different steps as described herein has been presented for the sake of clarity. In general, these steps can be performed in any suitable order. Additionally, although each of the different features, techniques, configurations, etc. herein may be discussed in different places of this disclosure, it is intended that each of the concepts can be executed independently of each other or in combination with each other. Accordingly, the present disclosure can be embodied and viewed in many different ways.

Furthermore, as used herein, the words “a,” “an,” and the like generally carry a meaning of “one or more,” unless stated otherwise.

Numerous modifications and variations are possible in light of the above teachings. It is therefore to be understood that within the scope of the appended claims, the disclosure can be practiced otherwise than as specifically described herein.

In one embodiment, the present disclosure is directed towards systems and methods for gating imaging data in order to reduce or remove unwanted data artifacts or effects. In one embodiment, the imaging data can be medical imaging data, and the unwanted data artifacts or effects can be associated with motion of a patient during image acquisition. In one example, the medical imaging data can be a sinogram that is acquired via position emission tomography (PET). Sinogram data can include time-of-flight (TOF) sinograms or non-TOF sinograms.

Sources of unwanted data artifacts can include cardiac and respiratory motion, which are involuntary cyclical motions. PET data can be used to image and assess the cardiac system. Motion artifacts and blurriness can result in overestimation of lesion volumes and underestimation of lesion activity. Motion correction is therefore an important part of image acquisition and reconstruction in order to generate an accurate medical image with high contrast and resolution. References herein to PET imaging can be understood as a non-limiting example of medical imaging techniques that can be effectively processed using the methods of the present disclosure.

A traditional approach to motion correction in PET imaging involves using additional sensors, such as motion sensors or cameras, to physically track patient motion during image acquisition. Motion data acquired by the motion sensors can then be synchronized with imaging data in order to identify the effect of patient motion on the imaging data. However, the use of sensors during a PET imaging scan can be cumbersome, time-consuming, and prone to user error.

Data-driven gating can be used to identify and extract imaging data associated with motion by processing the imaging data itself. In one embodiment, data-driven gating can depend on cyclical periods associated with different types of patient motion. For example, respiration occurs on a longer timescale than the cardiac cycle. Patterns of motion can be identified across different timescales. Data-driven gating for removing motion artifacts can reduce the complexity of image acquisition and processing compared to methods that rely on separate streams of motion data.

In one embodiment, a method for data-driven gating can include segmenting acquired imaging data (e.g., PET data) into one or more bins (frames). The length of the bins can be set based on a type of biosignal and/or motion. Statistical transformations such as principal component analysis (PCA) and/or independent component analysis (ICA) can then be applied to the bins in order to identify and extract respiratory and cardiac motion signals. These statistical transformations are confined to a given set of acquired imaging data, which means that the analysis is repeated from scratch for each instance of image acquisition and is limited by the quality and conditions of each given set of acquired imaging data.

A neural network-based approach can improve the quality and efficiency of data-driven gating and can provide a more robust method for identifying and removing motion artifacts from imaging data. In one embodiment, the present disclosure is directed to a method of data-driven gating using a pre-trained neural network as a latent feature extractor. The neural network can include an encoder and a decoder. The neural network can be trained to encode imaging data to generate one or more latent feature vectors associated with the imaging data and use the one or more latent feature vectors to generate a reconstructed image that is corrected for patient motion. The generation of latent feature vectors by encoding imaging data can also be referred to as extraction of latent feature vectors.

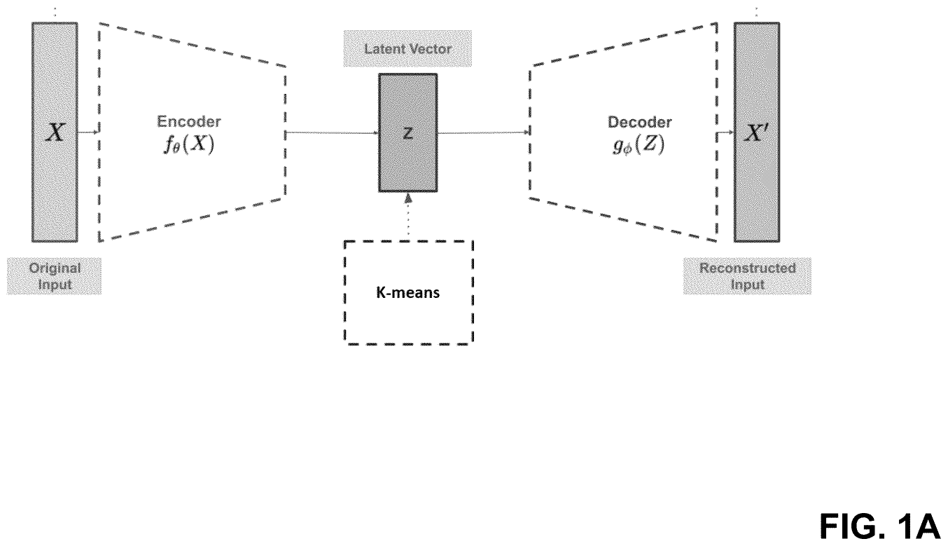

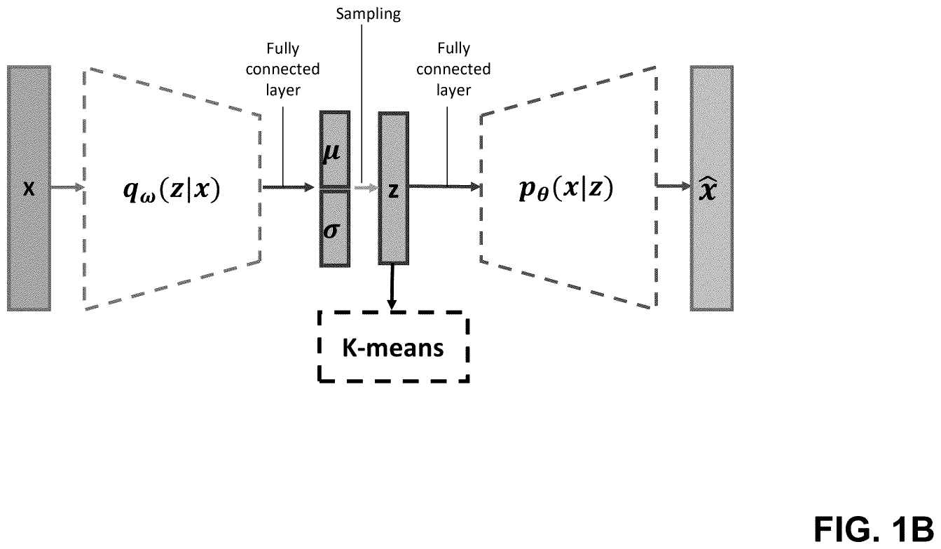

FIG. 1A is an example of a neural network used for data-driven gating, according to one embodiment. The input to the encoder f_{θ}(x) can be an image X. The encoder can encode the input image X as one or more latent features and can generate a latent feature vector Z based on the one or more latent features. The decoder g_{ø}(x) can output a reconstructed image X′ based on the latent feature vector Z. In one embodiment, latent feature vectors can be clustered or classified, e.g., by k-means clustering, as described in further detail elsewhere in this disclosure. In one embodiment, the input to the encoder can be a bin of imaging data. The encoder can be used to extract latent features from the bin of imaging data. The decoder can then be used to reconstruct the bin of imaging data based on the encoding.

Imaging data corresponding to an input image X can be input to the encoder. The input image can be two-dimensional image such as a sinogram or a three-dimensional imaging volume. The imaging data can be list-mode data, wherein the imaging data is arranged sequentially in time. In one embodiment, the imaging data can be binned into segments. The encoder can extract a set of feature vectors Z including latent features from the input image X. In one embodiment, the extracted feature vectors Z can be clustered into one or more clusters of feature vectors Z. The clustering can be based on temporal or phase characteristics, which will be described in further detail herein. The clustering of the extracted feature vectors can be part of the gating process to eliminate motion artifacts within a cluster of extracted feature vectors. The clusters of feature vectors Z can be input to a decoder. The decoder can generate a reconstructed image X′ based on the clusters of feature vectors. As an example, the input image can be 200×200×100 three-dimensional imaging data. The imaging data can be converted to a 64×64×200 latent feature vector. The latent feature vectors can be used to generate an approximation of the input image. The imaging data can be corrected or uncorrected imaging data. Correction of imaging data can include, for example, scatter correction, attenuation correction, or denoising.

FIG. 1B is an example of a neural network used for data-driven gating, according to one embodiment. The input to a neural network encoder q_{ω}(z|x) can be an image X. The encoder can also be referred to as a feature extractor or feature extraction neural network. The encoder can encode the input image X to output a preliminary output. The preliminary output of the encoder can be further processed by one or more error functions in fully connected layers. For example, the error functions can include a root mean square error function and a mean square error function. During pre-training, the encoder can be trained to generate a low-dimensional representation for each input image by minimizing the mean squared errors (MSE) between its input and output. In one embodiment, the encoder can provide a non-linear mapping function, and the decoder can demand accurate data reconstruction from the representation generated by the encoder. In one embodiment, the preliminary output of the encoder can be sampled, e.g., with a variational autoencoder. In one embodiment, the sampling of the preliminary output can result in latent feature vectors Z. The latent feature vectors Z can be clustered, e.g., with a k-means clustering model. The clustered latent feature vectors Z can then be input to a neural network decoder p_{θ}(x|z). The decoder can use the clustered latent feature vectors Z to generate a reconstructed image \hat{x}. For example, the clustered latent feature vectors can be used as gating rules for regrouping images. The decoder can then generate a reconstructed image based on the regrouping according to the clustered latent feature vectors. The latent feature vectors Z are more suitable for respiratory gating using a clustering algorithm than the input imaging data.

In one embodiment, the input imaging data can be binned into short segments (also referred to as bins or frames). The length of the bins can be set such that the imaging data within a bin corresponds to a phase of motion. For example, respiratory motion can be broken down into at least four phases: a first phase of inhalation (inspiration), a second phase of inspiratory pause, a third phase of exhalation (expiration), and a fourth phase of expiratory pause. Within each of the four phases, the patient may be stationary or may exhibit the same type of motion. For example, during inhalation, the diaphragm moves downward and the lungs expand, while during exhalation, the diaphragm moves upward and the lungs recoil to expel air. Segmenting the input imaging data based on the length of the respiratory phases can reduce or eliminate the effect of respiratory motion within each bin. In one example, the length of each segment can be between 0.05 to 2.0 seconds. The length of each segment can correspond to a duration of a phase of motion.

In one embodiment, the input imaging data can be segmented into M segments corresponding to at least N phases of motion. In one example, N can be 4 phases of respiratory motion. However, it can be appreciated that the phases of motion are not limited to respiratory motion and can refer to motion that occurs on a longer or shorter timescale. The duration (length) of each of the N phases of motion can be uniform or can be different. The duration of each of the N phases of motion can be shorter than the cycle of motion as a whole. In one embodiment, M can be at least equal to N. For example, the input imaging data can be divided into at least one segment per phase of motion. The segmenting of the input imaging data can be performed by dividing or extracting list mode data for each segment.

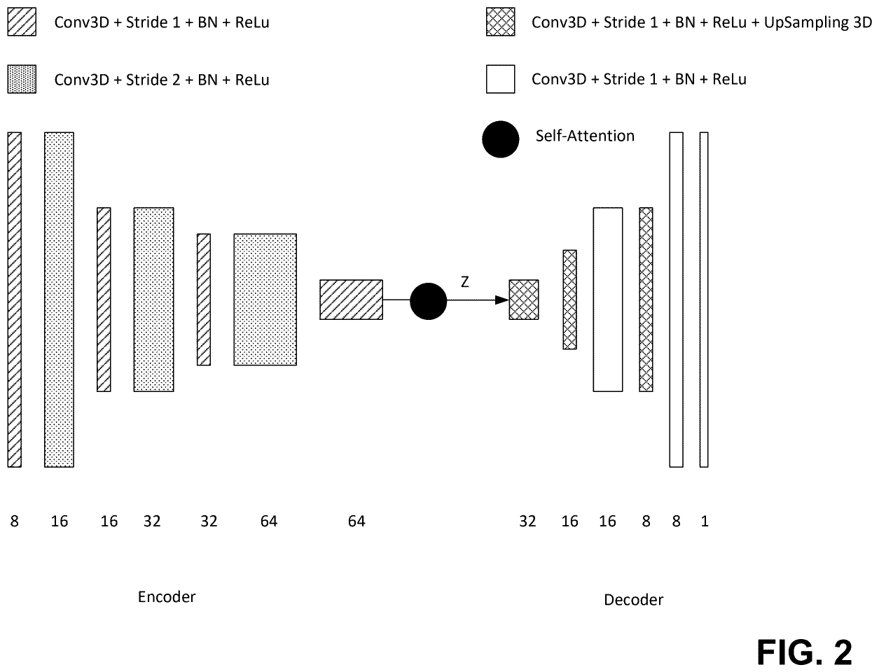

FIG. 2 is an illustration of an encoder/decoder model architecture, according to one embodiment of the present disclosure. The model can include convolutional layers (Conv), batch normalization (BN), and activation functions (e.g., rectified linear unit (ReLu)). The model can include a self-attention gate, such as the self-attention gate described in H. Zhang, I. Goodfellow, D. Metaxas, and A. Odena, “Self-attention generative adversarial networks,” arXiv preprint arXiv:1805.08318, 2018, the contents of which are incorporated herein by reference. The self-attention gate can increase model sensitivity response to a large range of imaging data. In one example, the model of FIG. 2 can be implemented in Keras with a Tensorflow backend and trained on a graphics processing unit (GPU) in conjunction with the adaptive moment estimation (ADAM) optimizer with default parameter settings. As an example, the model parameters during training can include a learning rate of 0.0001, batch size of 1, and 10 epochs.

In one embodiment, the encoder can be an autoencoder and can include seven layers, each layer including 3D convolution (kernel size 3×3×3), batch normalization (BN), and a rectified linear unit (ReLu). For example, the layers can alternate between 3D convolution, batch normalization, and activation with a first stride (or step) length and 3D convolution, batch normalization, and activation with a second stride (or step) length. The layers can have varying sizes, as illustrated in FIG. 2. In one embodiment, the autoencoder can include a self-attention module after the encoding layers configured to calculate a response at a position in a dataset (e.g., a feature space or feature map) as a weighted sum of features at all positions in the feature map. The self-attention module enables the network to learn to suppress irrelevant features in an input image and highlight relevant features in the input image based on internal relationships in the feature space. The output from the self-attention module is a set of latent feature vectors Z that is then used for the reconstruction/decoding. The latent feature vectors Z can be clustered prior to decoding.

In one embodiment, the decoder can include six layers. Each layer can include 3D convolution (kernel size 3×3×3), batch normalization (BN), and a rectified linear unit (ReLu). A layer can also include 3D upsampling. For example, FIG. 2 illustrates a decoder having three layers with upsampling and three layers without upsampling. The layers can have varying sizes, as illustrated in FIG. 2.

In one embodiment, the encoder can include any type of neural network and neural network architectures, including, but not limited to, autoencoders, an AlexNet convolutional neural network (CNN), a VGGNet CNN, etc. In general, the encoder can include deeply stacked fully connected layers with convolutional filters, one or more max pooling layers, one or more dropout layers, and an activation function (e.g., a rectified linear unit (ReLU) activation function). The encoder can be trained to extract latent features from input images of each bin and output a latent feature vector for each bin. The latent feature vector can be generated based on one or more extracted latent features. The latent feature vector can be associated with a single image or a bin (series) of images.

The latent feature vectors can be generated based on binned data. For example, an encoder can be used to generate one or more latent feature vectors for a bin of imaging data spanning approximately 0.1 to approximately 0.5 seconds. Longer (e.g., 1 to 2 seconds) and shorter (e.g., 0.05 seconds) bins of imaging data are also compatible with the present disclosure. The use of short bins of imaging data can reduce the effect of motion on data captured within a single bin. Motion data can therefore be identified and extracted based on differences in the latent feature vectors encoded for different bins.

In one embodiment, the encoder can be trained to extract latent features as part of an encoder/decoder network. The decoder can use a latent feature vector of an image as an input and can output a reconstructed image based on the latent feature vector. The encoder/decoder network can be trained to encode an input image (via the encoder) as a latent feature vector and decode the latent feature vector (via the decoder) to generate a reconstructed image that is an accurate approximation of the input image to the encoder. In this manner, the encoder/decoder network can be trained using supervised learning. The input image to the encoder can serve as the target image for determining the accuracy of the decoder output.

The configurations (e.g., weights) of the encoder and the decoder can be set during training. For example, a backpropagation process can be used to modify weights in the encoder and decoder during training in order to improve the accuracy of the model. In one embodiment, the encoder/decoder network can be trained to minimize a loss function representing a difference between an input image X and an output image X′. An example of a loss function is shown in the following equation:

$$L = {‖ {x}_{t} - g ( f ( x ) ) ‖}^{2}$$

Wherein L is a measurement of loss, xₜ is the target image, f(x) is the encoder function, and g(x) is the decoder function. In one embodiment, the target image can be the input image x. The loss function can therefore represent the difference between the input image x and the decoded image that is reconstructed based on the encoded latent feature vector of the input image. Loss functions applicable to training the encoder/decoder pair include, but are not limited to, mean-squared-error (MSE), mean-absolute-error (MAE), and root-mean-square error (RMSE). In one embodiment, the encoder/decoder can be trained in a self-supervised fashion, e.g., the input image and the target image are the same images from a bin of images. To emphasize motion information extraction, the target data sets can also be replaced by the difference data sets between the current short frame data set and a short frame data set from a few frames later. In one embodiment, the encoder/decoder pair can be trained with additional data from an external sensor. Exemplary external sensors include, but are not limited to, a belt-based motion sensor, a camera, LIDAR, and breathing sensor (including, but not limited to, a microphone for detecting a breathing phase of a patient). The sensor data can be synchronized with the imaging data, and the encoder/decoder pair can be trained to extract features from the imaging data that correspond to artifacts in the motion data.

In one embodiment, the encoder can be pre-trained to extract latent features from image data using a set of training data rather than an input image from a patient who is being assessed. The decoder can also be pre-trained to reconstruct an image based on the latent feature vectors extracted from training data. The training data can include imaging data from a population of patients. Pre-training the encoder results in a more robust encoder that can effectively encode a wider variety of latent features in imaging data compared with an encoder that is trained from scratch on a single patient's imaging data. An encoder that is trained from scratch on a single patient's imaging data is only able to gate the imaging data that is used for training. The encoder is only optimized for the patient from whom the training data is acquired. In contrast, pre-training the encoder enables more comprehensive training with larger training data sets. The pre-trained encoder can then be used on new imaging data acquired from patients that were not part of the training data.

Furthermore, when an encoder is trained from scratch (rather than pre-trained) to assess a single patient's imaging data, there are temporal and computational constraints on the training process in order to deliver results in a timely manner and without requiring specialized hardware or software. In contrast, pre-training the encoder frontloads the temporal and computational costs, and the pre-trained encoder can then be used more widely for imaging data from different patients. For example, training data for pre-training can include patients having different breathing frequencies, lung capacities, etc.

A pre-trained encoder can be more complex and can include more layers and channels because the pre-training is only performed once in advance of deployment of the model. The encoder can be pre-trained using a number of training data sets and/or network training methods. In one embodiment, the pre-trained encoder may not require any additional training or modification for a specific patient. In one embodiment, the pre-trained encoder can be fine-tuned based on a particular input image or series of images. Pre-training the encoder can reduce the time and processing power needed for clinical use of the encoder in gating imaging data.

The pre-trained encoder can be trained as part of an encoder/decoder network using a set of training data. The set of training data can include one or more series of images. For example, the set of training data can one or more samples of PET imaging data. In one embodiment, the PET imaging data can be acquired from a certain group or population. For example, the population can be defined by a characteristic such as an age, size, respiratory health, etc. In one embodiment, training data can be acquired from different populations. The training data can include a population characteristic or label.

In one embodiment, the set of training data can be segmented into bins prior to training of the model. For example, the bins can correspond to different phases of motion of approximately 0.1 to 0.5 seconds in duration. In one embodiment, the encoder/decoder network can be trained with varying bin size and/or overlap.

In one embodiment, the target image used for pre-training the encoder/decoder network can be different from the input image. For example, the encoder/decoder network can be trained using a series of images acquired from timestep t=0 to timestep t=100. At each timestep, the encoder/decoder network can be used to generate a reconstructed image from the input image corresponding to the timestep. A loss function can be calculated to represent the difference between the reconstructed image and a target image. The target image can be the input image corresponding to the present timestep or can be an image corresponding to a different timestep in the series. For example, the target image can be a later image from a later timestep. In one embodiment, the target image can be a difference image between images at two different timesteps, e.g., the present timestep and a future timestep.

The pre-trained encoder can be used to generate latent feature vectors for each bin of input imaging data. In one embodiment, the latent feature vectors for each bin can be clustered and/or classified. In one embodiment, the latent feature vectors can be clustered using a machine learning model (e.g., a classifier). Clustering methods can include, but are not limited to, unsupervised methods (e.g., Gaussian Mixture Model, Spectral Clustering, and SVM) and/or supervised methods (e.g., Logistic regression, Naive Bayes, and Decision tree). Such clustering methods can further include pre-processing steps to obtain initial cluster centers. For example, principal component analysis (PCA) can first be applied to the latent features and phase-based gating (e.g., based on respiratory cycles) can performed using the first principal component to obtain the initial cluster centers. Furthermore, to encourage the clustering to emphasize the respiratory motion, each latent feature vector can be weighted by the maximum magnitude of the frequency component contained by the latent feature vector inside the human breathing frequency range (such as 0.14-0.33 Hz).

Bins can be combined and gated based on the clustering of their extracted latent feature vectors. Bins with similar extracted feature vectors can be combined in a cluster because it is likely that these bins were acquired during the same phase of a respiratory or cardiac cycle. The effect of respiratory and/or cardiac motion likely does not differ significantly between bins that have clustered (similar) extracted feature vectors. The clustering of the extracted latent feature vectors can therefore exclude the effect of respiratory and/or cardiac motion within a group of bins. Clusters of feature vectors of similar segments can then be reconstructed. In one embodiment, the reconstruction process can include gate validation. As an example, gate (clusters of latent feature vectors) validation can include cross correlating a reconstructed image signal with a network-derived to ensure the robustness of the data-driven reconstructed image signal. In one example, the gates can be validated by identifying a respiratory phase associated with a cluster and verifying the respiratory phase using a different type of medical imaging data, such as CT data or MRI data. In one embodiment, an external signal can be used to interpolate estimated feature vectors corresponding to motion for higher temporal resolution.

Methods for reconstruction can include, but are not limited to, filtered back projection (FBP) or ordered subset expectation maximization (OSEM). Reconstructing a group of images that have similar extracted latent feature vectors can reduce blur or other artifacts associated with motion. Additional detail about the clustering of latent feature vectors and image reconstruction is provided in U.S. patent application Ser. No. 17/965,289, filed Oct. 13, 2022, which is incorporated herein by reference in its entirety.

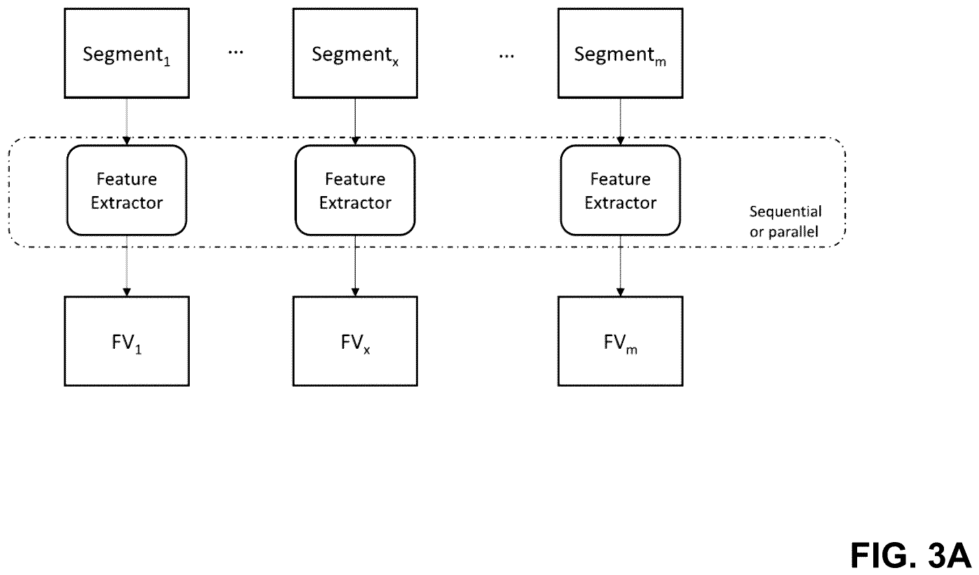

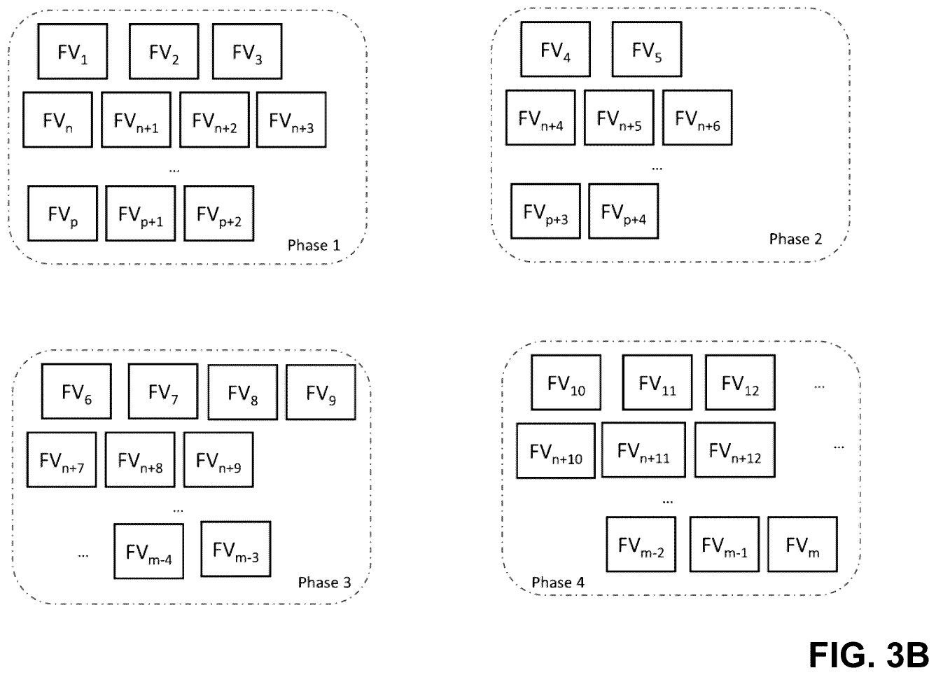

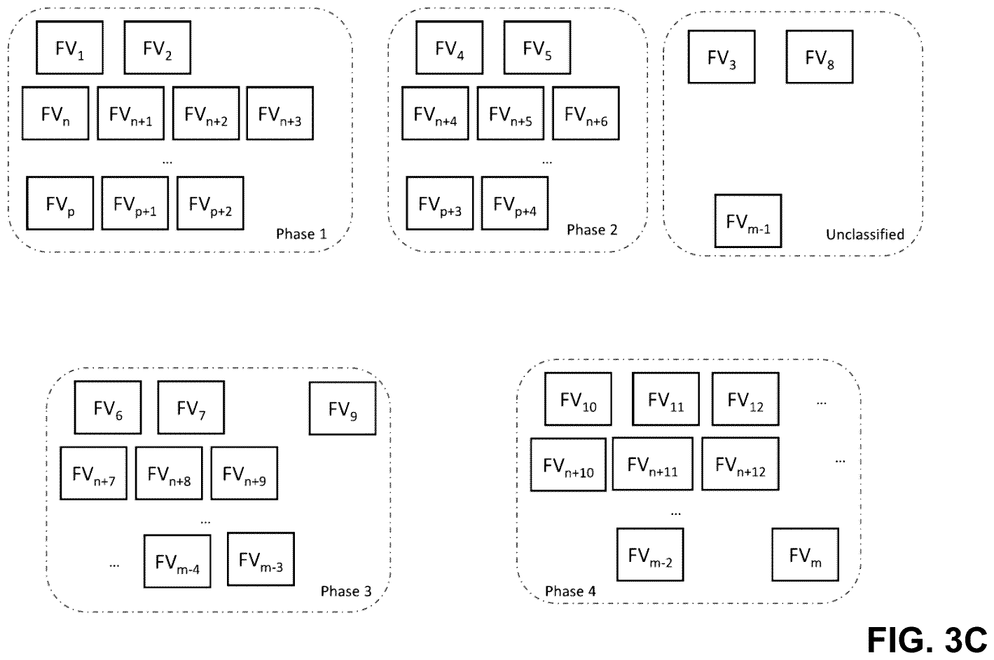

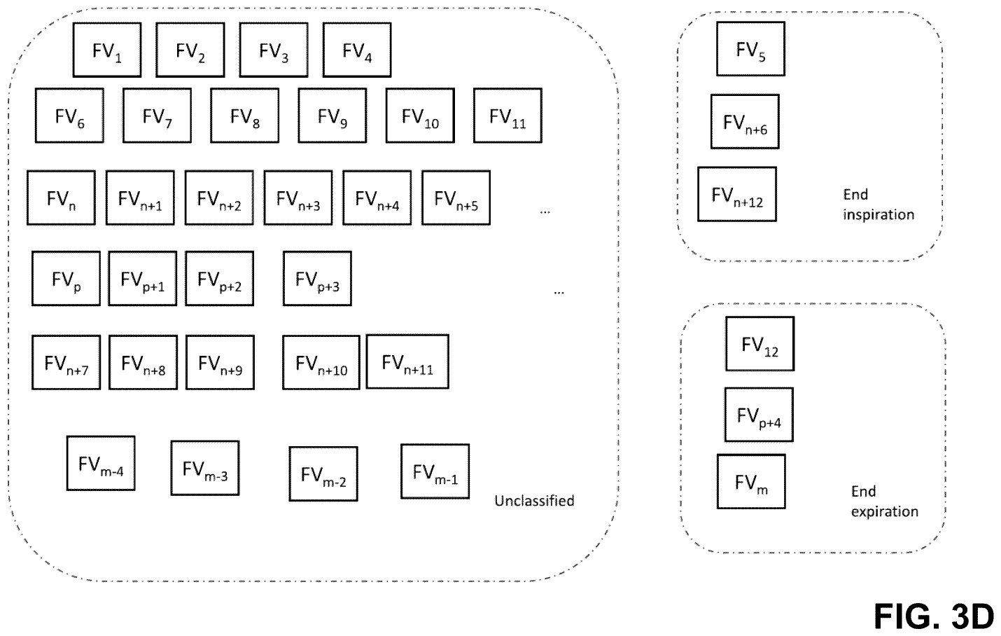

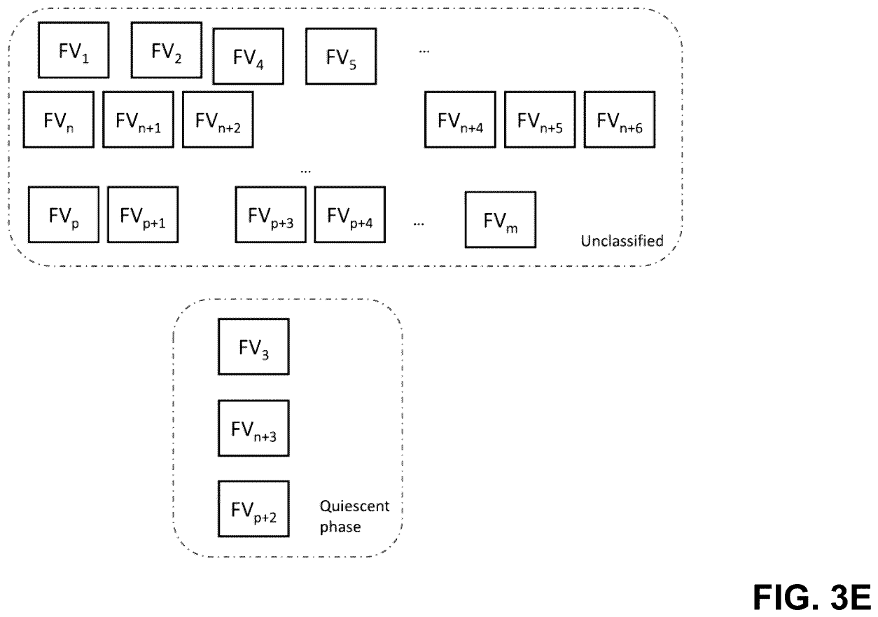

FIG. 3A is an illustration of the encoding process according to one embodiment. The encoder can be pre-trained to extract feature vectors from each segment of imaging data. The extraction from different segments can be performed sequentially, in parallel, or partially in parallel. The feature extraction can be performed by a single feature extractor or a series of feature extractors. In one embodiment, different feature extractors can include different model weights based on the training of the feature extractors. FIG. 3B is an illustration of the clustering of feature vectors generated by the encoder of FIG. 3A. In one embodiment, the clustering can correspond to phases of motion or types of motion. In one embodiment, the clusters of feature vectors can be unlabeled. The clusters of feature vectors can then be used to reconstruct an image on a set-by-set basis as part of a gated reconstruction. For example, the phase 1 cluster including feature vectors from segments 1, 2, n, n+1, n+2, n+3, . . . p, p+1, p+2 can be used to reconstruct an image as a group. The phase 2 cluster including feature vectors from segments 4, 5, n+4, n+5, n+6, . . . p+3, p+4 can be used to reconstruct an image as a group. The phase 3 cluster including feature vectors from segments 6, 7, 8, 9, n+7, n+8, n+9, . . . m−4, m−3 can be used to reconstruct an image as a group. The phase 4 cluster including feature vectors from segments 10, 11, 12, n+10, n+11, n+12, . . . m−2, m−1, m can be used reconstruct an image as a group. In this manner, a single (list-mode) series of imaging data can be gated to more accurately reconstruct images. Using each cluster as a set can result in a reconstructed image that does not include motion artifacts from the combination of different phases of motion.

FIG. 3C is an illustration of a clustering of feature vectors wherein a number of feature vectors are unclassified. In one embodiment, the unclassified feature vectors can be excluded from the image reconstruction process. FIG. 3D is an illustration of a clustering of feature vectors into a first phase corresponding to the end of inspiration and a second phase corresponding to the end of expiration. Feature vectors that do not fall into the first phase or the second phase can be treated as unclassified. The feature vectors of each phase can be reconstructed as a group and independently of the other phases. In one embodiment, the unclassified feature vectors can be reconstructed as a group. For example, the unclassified feature vectors can correspond to phases where the most motion occurs. FIG. 3E is an illustration of a clustering of feature vectors into a quiescent phase. The quiescent phase feature vectors can be reconstructed as a group. The remaining feature vectors can be unclassified. Unclassified feature vectors may or may not be used for reconstruction.

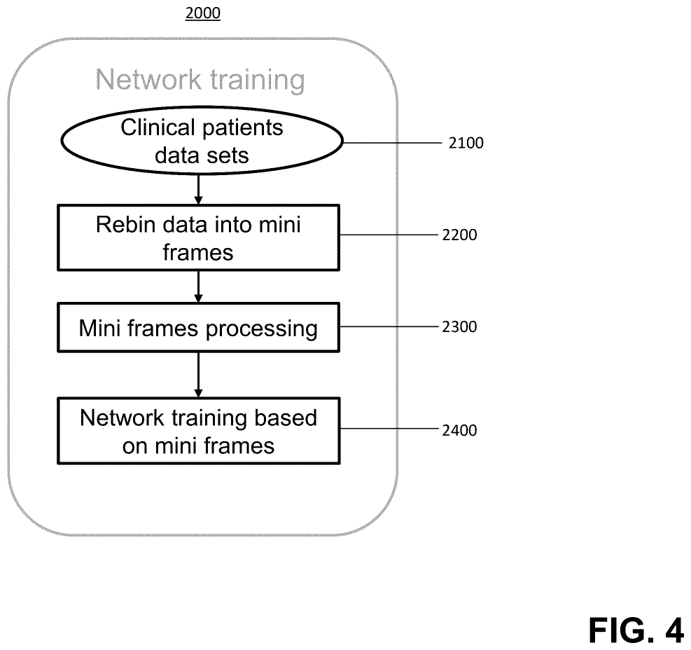

FIG. 4 is an illustration of a method 2000 for pre-training of the encoder according to one embodiment of the present disclosure. Clinical patient data sets can be acquired as training data in step 2100 to pre-train the network. In step 2200, the training data can be rebinned into small (mini) frames e.g., 0.1 to 0.5 seconds. The bin sizes can correspond to phases of motion. In step 2300, the bins can be pre-processed with any suitable image processing techniques. In step 2400, the encoder can be trained to extract latent features from images using the clinical patient data sets as training data. The encoder can be trained as part of an encoder/decoder network as described herein.

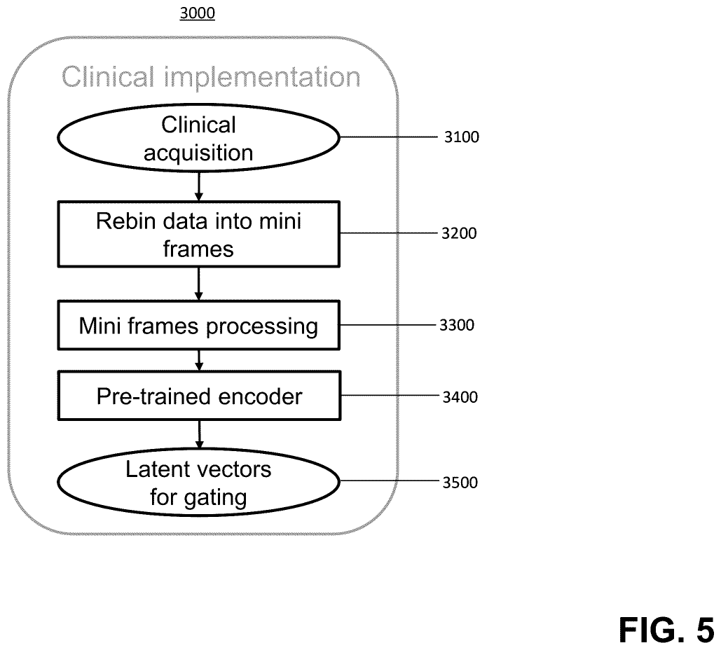

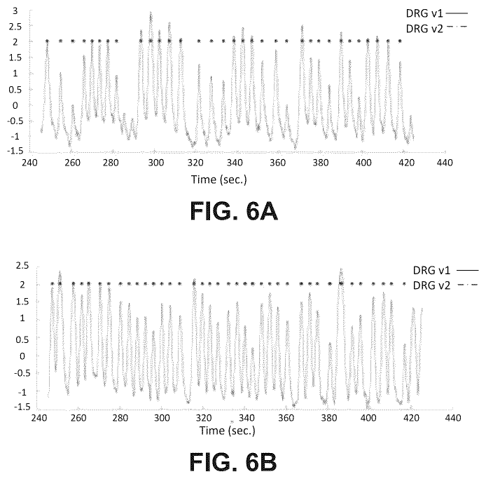

FIG. 5 is an illustration of a method 3000 for clinical implementation of a pre-trained encoder. The pre-trained encoder can be trained via the method 2000 of FIG. 4. Imaging data (e.g., a PET scan) can be acquired in a clinical setting in step 3100. In step 3200, the clinical imaging data can be rebinned. In one embodiment, the rebinning of the clinical imaging data can be the same as or similar to the rebinning of the training data in step 2200 of FIG. 4. For example, the bins of the clinical imaging data can have the same length and overlap as the bins of the training data. In step 3300, the clinical imaging data can be pre-processed with any suitable image processing techniques, as in step 2300 of FIG. 4. In step 3400, the pre-trained encoder can be used to encode the clinical imaging data in order to generate latent feature vectors. In step 3500, the latent feature vectors can be clustered and used to gate the clinical imaging data based on feature similarity. The clustered latent feature vectors can then be used to generate a reconstructed image. For example, the imaging data can be gated (grouped) based on the clustered latent feature vectors. The imaging data can be reconstructed by a decoder in sets, wherein the sets are based on the clusters of feature vectors, e.g., as illustrated in FIGS. 3A-3D. It can be appreciated that the methods of FIG. 4 and FIG. 5 can be used in combination with other image processing and/or gating techniques.

In one example, the encoder/decoder model was trained using training data acquired from a population (population dataset). The example training data included 42 PET scans acquired from 27 clinical patients by a TOF, SiPM-based PET scanner. 1-3 bed-position scans were acquired from each patient. The scans were from 180 to 240 seconds in duration. The scans acquired for training data were longer than scans acquired in a clinical setting because the pre-training of the model using the training data could be performed separately from clinical assessment using the model. Each image in the training data could be used to train a separate autoencoder, and the pre-trained autoencoders can be averaged to create the final model. As an example, each encoder/decoder model was trained using a batch size of 1, learning rate of 0.0001, and 3 epochs.

The accuracy of a pre-trained encoder/decoder can be evaluated by using the pre-trained encoder to extract respiratory waveforms using PCA. The pre-trained encoder/decoder model can extract a respiratory waveform by encoding the training data into latent feature vectors, clustering the latent feature vectors, and reconstruct a respiratory waveform based on a cluster of latent feature vectors. Multiple or single automatic gating can be applied to the latent feature vectors. Respiratory motion triggers can be generated by finding the local maxima of an extracted respiratory waveform.

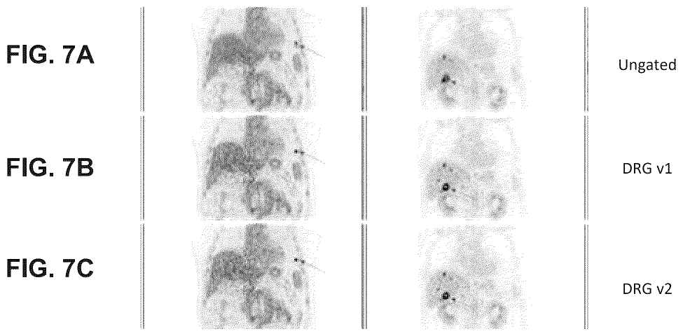

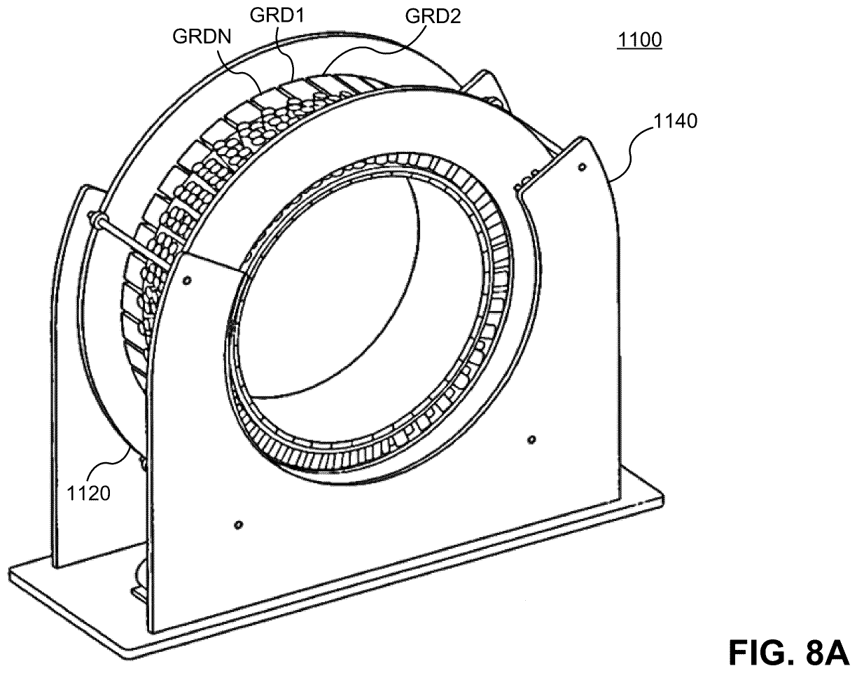

FIGS. 7A and 7B are respiratory waveforms extracted by the pre-trained encoder for a first patient (FIG. 7A) and a second patient (FIG. 7B). The imaging data from the first patient and the second patient are not included in the training data supplied to the pre-trained encoder. Pre-trained encoder/decoder models can extract respiratory waveforms and respiratory motion triggers for a patient with the same accuracy as an encoder/decoder model that is trained on the fly for the same patient. The pre-trained encoder/decoder models are more broadly applicable and can be used to accurately assess a new set of patient data after pre-training on a population dataset.

FIG. 7A illustrates a first reconstructed image generated by an ungated encoder/decoder model from imaging data from a first patient and a second reconstructed image generated by an ungated encoder/decoder model from imaging data from a second patient. FIG. 7B illustrates a first reconstructed image generated by a gated encoder/decoder model that is trained on the fly from imaging data from the first patient and a second reconstructed image generated by a gated encoder/decoder model that is trained on the fly from imaging data from the second patient. The encoder/decoder model of FIG. 7B is trained on the imaging data from the first patient (for the first image) and the imaging data from the second patient (for the second image). FIG. 7C illustrates a first reconstructed image generated by a gated pre-trained encoder/decoder model from imaging data from the first patient and a second reconstructed image generated by a gated pre-trained encoder/decoder model from imaging data from the second patient. The encoder/decoder model of FIG. 7C is trained on a population dataset that does not include the imaging data from the first patient and the second patient.

The images of FIG. 7A-7C were reconstructed with fully 3D list-mode TOF ordered-subset expectation-maximization (OSEM) with full physical corrections, including image-based point spread function (PSF) modeling and 2 mm voxels. A Gaussian filter with FWHM 4 mm was applied on the images to reduce the noise. The reconstruction using the gated encoder/decoder models had improved contrast and more visible lesions. The pre-trained gated encoder/decoder model is able to reconstruct a high-quality image that is comparable to the encoder/decoder model that is trained on the fly even though the imaging data from the first patient and the second patient were not included in the pre-training dataset.

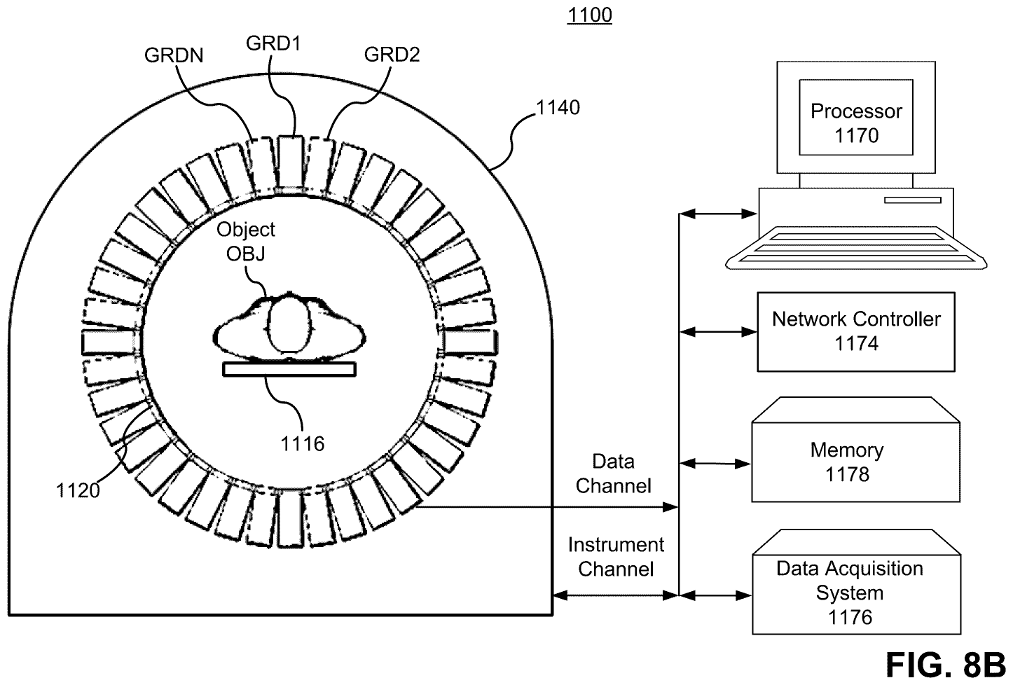

FIG. 8A and FIG. 8B show a non-limiting example of a PET scanner 1100 that can acquire imaging data and/or implement the methods 2000 and 3000. The PET scanner 1100 includes a number of gamma-ray detectors (GRDs) (e.g., GRD1, GRD2, through GRDN) that are each configured as rectangular detector modules. According to one implementation, the detector ring includes 40 GRDs. In another implementation, there are 48 GRDs, and the higher number of GRDs is used to create a larger bore size for the PET scanner 1100.

Each GRD can include a two-dimensional array of individual detector crystals, which absorb gamma radiation and emit scintillation photons. The scintillation photons can be detected by a two-dimensional array of photomultiplier tubes (PMTs) that are also arranged in the GRD. A light guide can be disposed between the array of detector crystals and the PMTs.

Alternatively, the scintillation photons can be detected by an array a silicon photomultipliers (SiPMs), and each individual detector crystals can have a respective SiPM.

Each photodetector (e.g., PMT or SiPM) can produce an analog signal that indicates when scintillation events occur, and an energy of the gamma ray producing the detection event. Moreover, the photons emitted from one detector crystal can be detected by more than one photodetector, and, based on the analog signal produced at each photodetector, the detector crystal corresponding to the detection event can be determined using Anger logic and crystal decoding, for example.

FIG. 8B shows a schematic view of a PET scanner system having gamma-ray (gamma-ray) photon counting detectors (GRDs) arranged to detect gamma-rays emitted from an object OBJ. The GRDs can measure the timing, position, and energy corresponding to each gamma-ray detection. In one implementation, the gamma-ray detectors are arranged in a ring, as shown in FIGS. 8A and 8B. The detector crystals can be scintillator crystals, which have individual scintillator elements arranged in a two-dimensional array and the scintillator elements can be any known scintillating material. The PMTs can be arranged such that light from each scintillator element is detected by multiple PMTs to enable Anger arithmetic and crystal decoding of scintillation event.

FIG. 8B shows an example of the arrangement of the PET scanner 1100, in which the object OBJ to be imaged rests on a table 1116 and the GRD modules GRD1 through GRDN are arranged circumferentially around the object OBJ and the table 1116. The GRDs can be fixedly connected to a circular component 1120 that is fixedly connected to the gantry 1140. The gantry 1140 houses many parts of the PET imager. The gantry 1140 of the PET imager also includes an open aperture through which the object OBJ and the table 1116 can pass, and gamma-rays emitted in opposite directions from the object OBJ due to an annihilation event can be detected by the GRDs and timing and energy information can be used to determine coincidences for gamma-ray pairs.

In FIG. 8B, circuitry and hardware is also shown for acquiring, storing, processing, and distributing gamma-ray detection data. The circuitry and hardware include: a processor 1170, a network controller 1174, a memory 1178, and a data acquisition system (DAS) 1176. The PET imager also includes a data channel that routes detection measurement results from the GRDs to the DAS 1176, the processor 1170, the memory 1178, and the network controller 1174. The DAS 1176 can control the acquisition, digitization, and routing of the detection data from the detectors. In one implementation, the DAS 1176 controls the movement of the bed 1116. The processor 1170 performs functions including reconstructing images from the detection data, pre-reconstruction processing of the detection data, and post-reconstruction processing of the image data, as discussed herein.

The processor 1170 can be configured to perform various steps of methods 2000 and/or 3000 described herein and variations thereof. The processor 1170 can include a CPU that can be implemented as discrete logic gates, as an Application Specific Integrated Circuit (ASIC), a Field Programmable Gate Array (FPGA) or other Complex Programmable Logic Device (CPLD). An FPGA or CPLD implementation may be coded in VHDL, Verilog, or any other hardware description language and the code may be stored in an electronic memory directly within the FPGA or CPLD, or as a separate electronic memory. Further, the memory may be non-volatile, such as ROM, EPROM, EEPROM or FLASH memory. The memory can also be volatile, such as static or dynamic RAM, and a processor, such as a microcontroller or microprocessor, may be provided to manage the electronic memory as well as the interaction between the FPGA or CPLD and the memory.

Alternatively, the CPU in the processor 1170 can execute a computer program including a set of computer-readable instructions that perform various steps of method 2000 and/or method 3000, the program being stored in any of the above-described non-transitory electronic memories and/or a hard disk drive, CD, DVD, FLASH drive or any other known storage media. Further, the computer-readable instructions may be provided as a utility application, background daemon, or component of an operating system, or combination thereof, executing in conjunction with a processor, such as a Xenon processor from Intel of America or an Opteron processor from AMD of America and an operating system, such as Microsoft VISTA, UNIX, Solaris, LINUX, Apple, MAC-OS and other operating systems known to those skilled in the art. Further, CPU can be implemented as multiple processors cooperatively working in parallel to perform the instructions.

The memory 1178 can be a hard disk drive, CD-ROM drive, DVD drive, FLASH drive, RAM, ROM or any other electronic storage known in the art.

The network controller 1174, such as an Intel Ethernet PRO network interface card from Intel Corporation of America, can interface between the various parts of the PET imager. Additionally, the network controller 1174 can also interface with an external network. As can be appreciated, the external network can be a public network, such as the Internet, or a private network such as an LAN or WAN network, or any combination thereof and can also include PSTN or ISDN sub-networks. The external network can also be wired, such as an Ethernet network, or can be wireless such as a cellular network including EDGE, 11G and 4G wireless cellular systems. The wireless network can also be WiFi, Bluetooth, or any other wireless form of communication that is known.

While this specification contains many specific implementation details, these should not be construed as limitations on the scope of what may be claimed, but rather as descriptions of features that may be specific to particular embodiments.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

In the preceding description, specific details have been set forth, such as a particular geometry of a processing system and descriptions of various components and processes used therein. It should be understood, however, that techniques herein may be practiced in other embodiments that depart from these specific details, and that such details are for purposes of explanation and not limitation. Embodiments disclosed herein have been described with reference to the accompanying drawings. Similarly, for purposes of explanation, specific numbers, materials, and configurations have been set forth in order to provide a thorough understanding. Nevertheless, embodiments may be practiced without such specific details. Components having substantially the same functional constructions are denoted by like reference characters, and thus any redundant descriptions may be omitted.

Various techniques have been described as multiple discrete operations to assist in understanding the various embodiments. The order of description should not be construed as to imply that these operations are necessarily order dependent. Indeed, these operations need not be performed in the order of presentation. Operations described may be performed in a different order than the described embodiment. Various additional operations may be performed and/or described operations may be omitted in additional embodiments.

Embodiments of the present disclosure may also be set forth in the following parentheticals.

(1) A method for gating positron emission tomography (PET) data, the method comprising: receiving tomography data acquired by imaging an object using a PET apparatus; segmenting the received tomography data into a plurality of bins of tomography data; generating a latent feature vector for each bin of the plurality of bins of tomography data using a feature extraction neural network, the feature extraction neural network being pre-trained to extract latent feature vectors on a set of training data; clustering the generated latent feature vectors; and reconstructing an image using the received tomography data based on the clustering of the generated latent feature vectors.

(2) The method of (1), wherein the segmenting step includes segmenting the received tomography data into a plurality of bins, each bin of the plurality of bins being approximately 0.1 seconds to approximately 0.5 seconds in length.

(3) The method of (1) to (2), wherein the generating step includes encoding a bin of tomography data with a feature extraction neural network including a convolutional autoencoder having a self-attention module.

(4) The method of (1) to (3), wherein the generating step includes using a feature extraction neural network that is pre-trained to minimize a loss function between a reconstructed image and a target image, the target image being at least one of an input image of the set of training data input to the feature extraction network, another image of the set of training data different from the input image, or a difference image between the input image and another image of the set of training data.

(5) The method of (1) to (3), wherein the generating step further comprises generating the latent feature vector based on one or more latent features extracted by the feature extraction neural network.

(6) The method of (1) to (5), wherein the clustering step further comprises clustering the generated latent feature vectors using a machine-learning method.

(7) The method of (1) to (6), wherein the reconstructing step further comprises performing filtered back projection (FBP) or ordered subset expectation maximization (OSEM).

(8) The method of (1) to (7), wherein the clustering step further comprises clustering the generated latent feature vectors according to one or more phases of respiratory motion.

(9) A positron emission tomography (PET) apparatus, comprising processing circuitry configured to acquire tomography data by imaging an object using PET, segment the acquired tomography data into a plurality of bins of tomography data, generate a latent feature vector for each bin of the plurality of bins of tomography data using a feature extraction neural network, the feature extraction neural network being pre-trained to extract latent feature vectors on a set of training data, cluster the generated latent feature vectors, and reconstruct an image using the acquired tomography data based on the clustering of the generated latent feature vectors.

(10) The apparatus of (9), wherein the processing circuitry is further configured to segment the acquired tomography data into bins are approximately 0.1 seconds to approximately 0.5 seconds in length.

(11) The apparatus of (9) to (10), wherein the processing circuitry is further configured to generate the latent feature vector for each bin using the feature extraction neural network including a convolutional autoencoder having a self-attention module.

(12) The apparatus of (9) to (11), wherein the processing circuitry is configured to generate the latent feature vector for each bin using the feature extraction neural network that is trained to minimize a loss function between a reconstructed image and a target image, the target image being at least one of an input image from the set of training data input to the feature extraction network, another image of the set of training data different from the input image, or a difference image between the input image and another image of the set of training data.

(13) The apparatus of (9) to (12), wherein the processing circuitry is configured to generate the latent feature vector based on one or more latent features extracted by the feature extraction neural network.

(14) The apparatus of (9) to (13), wherein the processing circuitry is configured to cluster the generated latent feature vectors using a machine-learning method.

(15) The apparatus of (9) to (14), wherein the processing circuitry is configured to reconstruct the image by performing filtered back projection (FBP) or ordered subset expectation maximization (OSEM).

(16) The apparatus of (9) to (15), wherein the processing circuitry is configured to cluster the generated latent feature vectors according to one or more phases of respiratory motion.

(17) A non-transitory computer-readable storage medium for storing computer readable instructions that, when executed by a computer, cause the computer to perform a method, the method comprising receiving tomography data acquired by imaging an object using a PET apparatus; segmenting the received tomography data into a plurality of bins of tomography data; generating a latent feature vector for each of the bins using a feature extraction neural network, the feature extraction neural network being trained on a set of training data; clustering the generated latent feature vectors; and reconstructing an image using the received tomography data based on the clustering of the latent feature vectors.

(18) The non-transitory computer-readable storage medium of (17), wherein the segmenting step includes segmenting the received tomography data into a plurality of bins, each bin of the plurality of bins being approximately 0.1 seconds to approximately 0.5 seconds in length.

(19) The non-transitory computer-readable storage medium of (17) to (18), wherein the generating step includes encoding a bin of tomography data with a feature extraction neural network including a convolutional autoencoder having a self-attention module.

(20) The non-transitory computer-readable storage medium of (17) to (19), wherein the generating step includes using a feature extraction neural network that is pre-trained to minimize a loss function between a reconstructed image and a target image, the target image being at least one of an input image of the set of training data input to the feature extraction network, another image of the set of training data different from the input image, or a difference image between the input image and another image of the set of training data.

Obviously, numerous modifications and variations of the present invention are possible in light of the above teachings. It is therefore to be understood that within the scope of the appended claims, the invention may be practiced otherwise than as specifically described herein.

1. A method for gating positron emission tomography (PET) data, the method comprising:
receiving tomography data acquired by imaging an object using a PET apparatus;
segmenting the received tomography data into a plurality of bins of tomography data;
generating a latent feature vector for each bin of the plurality of bins of tomography data using a feature extraction neural network, the feature extraction neural network being pre-trained to extract latent feature vectors on a set of training data;
clustering the generated latent feature vectors; and
reconstructing an image using the received tomography data based on the clustering of the generated latent feature vectors.

2. The method of claim 1, wherein the segmenting step includes segmenting the received tomography data into a plurality of bins, each bin of the plurality of bins being approximately 0.1 seconds to approximately 0.5 seconds in length.

3. The method of claim 1, wherein the generating step includes encoding a bin of tomography data with a feature extraction neural network including a convolutional autoencoder having a self-attention module.

4. The method of claim 1, wherein the generating step includes using a feature extraction neural network that is pre-trained to minimize a loss function between a reconstructed image and a target image, the target image being at least one of an input image of the set of training data input to the feature extraction network, another image of the set of training data different from the input image, or a difference image between the input image and another image of the set of training data.

5. The method of claim 1, wherein the generating step further comprises generating the latent feature vector based on one or more latent features extracted by the feature extraction neural network.

6. The method of claim 1, wherein the clustering step further comprises clustering the generated latent feature vectors using a machine-learning method.

7. The method of claim 1, wherein the reconstructing step further comprises performing filtered back projection (FBP) or ordered subset expectation maximization (OSEM).

8. The method of claim 1, wherein the clustering step further comprises clustering the generated latent feature vectors according to one or more phases of respiratory motion.

9. A positron emission tomography (PET) apparatus, comprising:
processing circuitry configured to
acquire tomography data by imaging an object using PET,
segment the acquired tomography data into a plurality of bins of tomography data,
generate a latent feature vector for each bin of the plurality of bins of tomography data using a feature extraction neural network, the feature extraction neural network being pre-trained to extract latent feature vectors on a set of training data,
cluster the generated latent feature vectors, and
reconstruct an image using the acquired tomography data based on the clustering of the generated latent feature vectors.

10. The apparatus of claim 9, wherein the processing circuitry is further configured to segment the acquired tomography data into bins are approximately 0.1 seconds to approximately 0.5 seconds in length.

11. The apparatus of claim 9, wherein the processing circuitry is further configured to generate the latent feature vector for each bin using the feature extraction neural network including a convolutional autoencoder having a self-attention module.

12. The apparatus of claim 9, wherein the processing circuitry is configured to generate the latent feature vector for each bin using the feature extraction neural network that is trained to minimize a loss function between a reconstructed image and a target image, the target image being at least one of an input image from the set of training data input to the feature extraction network, another image of the set of training data different from the input image, or a difference image between the input image and another image of the set of training data.

13. The apparatus of claim 9, wherein the processing circuitry is configured to generate the latent feature vector based on one or more latent features extracted by the feature extraction neural network.

14. The apparatus of claim 9, wherein the processing circuitry is configured to cluster the generated latent feature vectors using a machine-learning method.

15. The apparatus of claim 9, wherein the processing circuitry is configured to reconstruct the image by performing filtered back projection (FBP) or ordered subset expectation maximization (OSEM).

16. The apparatus of claim 9, wherein the processing circuitry is configured to cluster the generated latent feature vectors according to one or more phases of respiratory motion.

17. A non-transitory computer-readable storage medium for storing computer readable instructions that, when executed by a computer, cause the computer to perform a method, the method comprising:
receiving tomography data acquired by imaging an object using a PET apparatus;
segmenting the received tomography data into a plurality of bins of tomography data;
generating a latent feature vector for each of the bins using a feature extraction neural network, the feature extraction neural network being trained on a set of training data;
clustering the generated latent feature vectors; and
reconstructing an image using the received tomography data based on the clustering of the latent feature vectors.

18. The non-transitory computer-readable storage medium of claim 17, wherein the segmenting step includes segmenting the received tomography data into a plurality of bins, each bin of the plurality of bins being approximately 0.1 seconds to approximately 0.5 seconds in length.

19. The non-transitory computer-readable storage medium of claim 17, wherein the generating step includes encoding a bin of tomography data with a feature extraction neural network including a convolutional autoencoder having a self-attention module.

20. The non-transitory computer-readable storage medium of claim 17, wherein the generating step includes using a feature extraction neural network that is pre-trained to minimize a loss function between a reconstructed image and a target image, the target image being at least one of an input image of the set of training data input to the feature extraction network, another image of the set of training data different from the input image, or a difference image between the input image and another image of the set of training data.
